(19) United States
(12) Patent Application Publication
(10) Pub. No.: US 2024/0228274 A1
(43) Pub. Date: Jul. 11, 2024

(54) Process and plant for the production of synthesis gas and generation of process condensate

(71) Applicant: Topsoe A/S, Kgs. Lyngby (DK)

(72) Inventor: Per Juul DAHL, Vedbaek (DK)

(73) Assignee: Topsoe A/S, Kgs. Lyngby (DK)

(21) Appl. No.: 18/559,352

(22) PCT Filed: May 23, 2022
(86) PCT No.: PCT/EP2022/063905

§ 371 Date: Nov. 7, 2023

(30) Foreign Application Priority Data
May 25, 2021 (DK) PA202100545

(51) Int. Cl. C01B 3/38

(52) U.S. Cl. CPC C01B 3/38; C01B 2203/0233; C01B 2203/0244; C01B 2203/0288; C01B 2203/0294; C01B 2203/0495; C01B 2203/0894; C01B 2203/146

(57) ABSTRACT

Process and plant for producing a synthesis gas by catalytic steam reforming of a hydrocarbon feedstock in a steam reforming unit, further comprising a first and second shift conversion unit, wherein water is removed from the synthesis gas as a process condensate, wherein boiler feed water is introduced in the process, and wherein said process or plant produces at least two separate steam streams: a pure steam which is generated from at least a portion of said boiler feed water by the cooling of synthesis gas, and a process steam which is generated by evaporating at least a portion of the process condensate in a process condensate boiler (PC-boiler) by using synthesis gas, optionally together with pure steam and/or flue gas from the steam reforming unit. Process steam, and pure steam other than that from the PC boiler, are added to the first shift conversion unit, optionally also to the second second shift conversion unit.

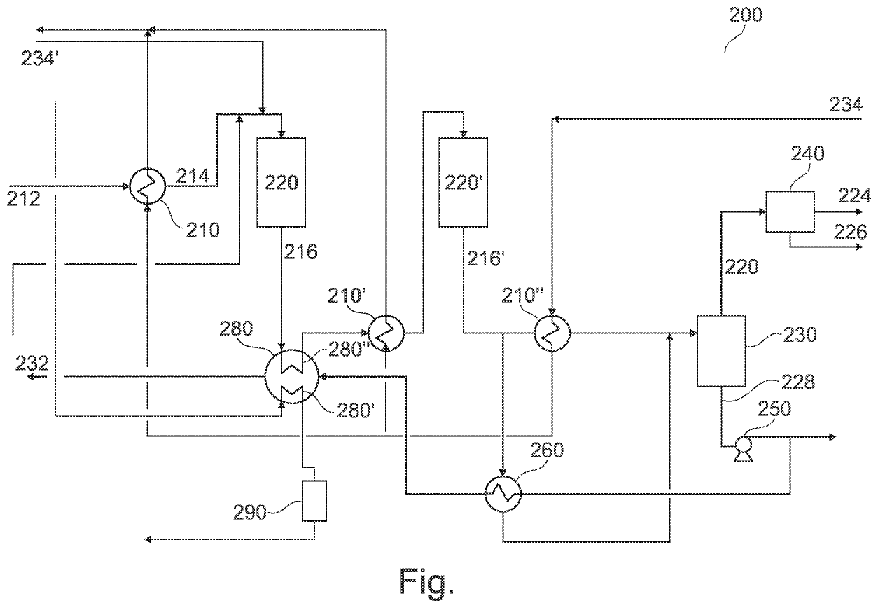

The present invention relates to a process and plant for producing a synthesis gas and/or a hydrogen product under the production of process steam originating from process condensate formed during the process, and which may be consumed internally in the process or plant, as well as pure steam as export steam which is generated from boiler feed water by the cooling of synthesis gas. The process/plant comprises a steam reforming unit and a first and second shift conversion unit, and the process steam and the pure steam are added to the first shift conversion unit, optionally also to the second shift conversion unit. The process steam and the pure steam are suitably mixed and added to the first shift for adjusting the steam/dry gas molar ratio of the gas entering the first shift conversion unit.

In processes and plants for producing of synthesis gas (syngas), i.e. a gas rich in hydrogen and carbon monoxide, the synthesis gas can be further used in the production of valuable intermediate or end products, for instance hydrogen. The synthesis gas is normally produced by so-called catalytic steam methane reforming and/or autothermal reforming. As a result of steam methane reforming, the synthesis gas (syngas) contains water which typically needs to be removed. The removal of water is normally conducted in a separator under the generation of a process condensate (PC) stream and a water-depleted synthesis gas stream. Also, as part of the process, boiler feed water (BFW) is used to indirectly cool the produced synthesis gas by means of so-called BFW-preheating units.

The BFW is thereby transformed into a saturated steam, also denoted as pure steam. This pure steam is normally free of impurities, i.e. contaminants, generated during the process such as carbon dioxide, methanol, ammonia and acetic acid, and thus this pure steam is suitable for use as export steam, since customers usually demand a high steam quality. On the other hand, such contaminants albeit in small amounts are present in the process condensate, so steam generated from this stream is not suitable for use as export steam.

Normally, process condensate is stripped with steam in a PC-stripper. The stripped process condensate is mixed with BFW and used for steam production and export steam. The stripped process condensate still contains small amounts of impurities which may contaminate the generation of pure steam.

US 2005/0288381 A1 discloses a method of recycling process stream condensate from a steam reforming system. Process steam is generated in a PC-boiler by heat exchange with a portion of pure steam generated in a separate steam production system. The process steam and the other portion of the pure steam are then combined and used to form a hydrocarbon/steam stream as feed for the steam reforming.

EP 3235785 A1 discloses a process in which process condensate is evaporated to form process steam by using a portion of the generated pure steam. For the generation of the pure steam, synthesis gas and flue gas from the steam reforming process is used.

EP 3235784 A1 is similar to EP 3235785 A1 and discloses a process in which process steam is generated by evaporating process condensate using pure steam as the heat exchanging medium.

GB 2006814 A discloses a process in which process steam is generated by a process condensate passing to circulation heating unit using pure steam as heat exchanging medium.

U.S. Pat. No. 9,556,026 discloses a process in which process steam is generated by heat exchange with synthesis gas of a water condensate in serially arranged heat exchanger units, and subsequently passing the thus preheated water condensate to a steam drum to make the process steam using flue gas from a steam methane reformer as heat exchanging medium.

U.S. Ser. No. 10/919,761 discloses a process in which synthesis gas from steam reforming (crude synthesis gas) is converted to a hydrogen rich gas mixture in a multistage water gas shift stage. Fresh steam is added to the crude synthesis gas as a reaction partner for the water gas shift and cooling of the converted synthesis gas generates an aqueous condensate.

Applicant's WO 201818162576 discloses a process where process condensate is stripped with a strip steam stream, which is then recycled to a first shift conversion unit.

EP 3138810 A1 is similar to above U.S. Pat. No. 95,566,026 B1. Both disclose methods for production of synthesis gas by catalytic steam reforming in a steam methane reformer (SMR). According to any of these citations, there are two different steam lines: a process steam line from a process condensate which is cooled via several heat exchangers by synthesis gas (syngas) from a shift unit downstream the SMR, and where the process steam ends up in a process steam drum; a separate “pure” steam line is generated from boiler feed water (BFW) passing through several heat exchangers, also by cooling syngas from the shift unit, and where the “pure” steam ends up in a separate “pure” steam drum. A combined steam from the process steam drum and pure steam drum is mixed with the hydrocarbon feed to the SMR. These citations seem to obviate the use of a process condensate stripper (PC-stripper). These citations do not address the issue of impurities such as methanol in the process steam, and further they are at least silent on the provision of a common PC-boiler for the cooling of syngas from the shift unit and evaporating BFW, as well as on the addition of process steam and pure steam to the shift unit. Nothing in any of these citations suggests the provision of these features, all the more considering that when operating with an SMR, there is no need for adding steam downstream.

It is an object of the present invention to avoid contamination of a pure steam used for steam export generated from boiler feed water with impurities from a process condensate stream formed during the process.

It is another object of the present invention to provide sufficient steam for the water gas shift while at the same time keeping the system transporting pure steam generated from BFW separated from the system transporting process condensate, in particular evaporated process condensate, as the process condensate contains impurities such as methanol which are undesired in some units of the plant to which the pure steam is led.

It is a further object of the present invention to be able to optimally control or adjust the steam/dry gas molar ratio of the gas entering the first shift conversion unit i.e. the synthesis gas inlet the first shift conversion unit.

These and other objects are solved by the present invention.

Accordingly, in a first aspect the invention is a process for producing a synthesis gas by catalytic steam reforming of a hydrocarbon feedstock in a steam reforming unit, said reforming unit optionally generating a flue gas, wherein water is removed from the synthesis gas as a process condensate, wherein boiler feed water is introduced in the process, and wherein said process produces at least two separate steam streams: i) a pure steam stream which is generated from at least a portion of said boiler feed water (BFW) by the cooling of synthesis gas, and ii) a process steam stream which is generated by evaporating at least a portion of the process condensate by the cooling of synthesis gas;
wherein step ii) is conducted in a process condensate boiler (PC-boiler);
wherein said steam reforming unit produces a raw synthesis gas, and said synthesis gas is a process gas produced by passing said raw synthesis gas through a catalytic water-gas shift (WGS) conversion stage comprising the use of one or more water-gas shift conversion units;
wherein said one or more water-gas shift conversion units comprises a first shift conversion unit such as a high or medium-temperature shift conversion unit (HT or MT-shift unit) and subsequently a second shift conversion unit such as a medium or low temperature shift conversion unit (MT or LT-shift unit), and optionally a third shift conversion unit such as a low temperature shift conversion unit (LT-shift unit), and wherein said cooling of the synthesis gas in step ii) is the cooling of a synthesis gas stream exiting said first or second shift conversion unit, e.g. said HT or MT-shift unit;
wherein at least a portion of the process steam stream and at least a portion of said pure steam stream are added to said first shift conversion unit, e.g. by adding to the raw synthesis gas; and
wherein in step i) said pure steam stream which is generated from at least a portion of said boiler feed water (BFW), comprises:
   i-1) pure steam generated at least partly by the cooling of the synthesis gas in one or more heat exchangers or boilers, such as in a BFW-preheating unit and in a waste heat boiler (WHB) prior to passing said raw synthesis gas through the catalytic water-gas shift (WGS) conversion stage; and/or
   i-2) pure steam generated by the cooling of said flue gas in one or more heat exchangers and boilers, such as in a BFW preheating unit and in a waste heat boiler (WHB), for instance by the cooling of said synthesis gas in step ii) i.e. in said PC-boiler.

By the invention, a single or common PC-boiler may be provided for the cooling of syngas from the shift unit and for evaporating BFW, and further there is addition of process steam and pure steam to the shift unit, as illustrated in the appended figure.

In an embodiment according to the first aspect of the invention, in step i-1) and/or i-2) said pure steam stream consists of: pure steam generated in one or more boilers except for a boiler for cooling the synthesis gas from the first shift conversion unit, such as said PC-boiler. Accordingly, pure steam stream which is generated from at least a portion of said boiler feed water (BFW) by the cooling of synthesis gas, does not include pure steam after being used for generating the process steam stream, i.e. pure steam after being passed through said PC-boiler.

While pure steam after being used in said PC-boiler, that is, after boiling the BFW therein, may be part of the pure steam which is added to the shift unit(s), it may sometimes be desirable not to include such pure steam from the PC-boiler and instead simply collecting and withdrawing it.

Hence, process steam as well as pure steam generated in the process/plant elsewhere than in the PC boiler of step ii), are added to the first shift conversion unit. It has been found, that thereby it is possible to increase the amount of steam necessary for the WGS conversion compared to the prior art, while at the same time increasing plant flexibility, control and capacity, as explained farther below.

More generally, the pure steam from the BFW preheating units and waste heat boilers, optionally including pure steam from the PC-boiler between the first and second shift conversion units, is passed to a common steam system which comprises a grid i.e. a pipe network adapted for transporting pure steam generated in said waste heat boilers as well as transporting said pure steam stream used during the generation of said process steam stream. The pipe network includes suitably also condensate pots and/or condensate drums to collect the pure stream.

From the grid, a portion of the pure steam contained herein may be conducted into the first shift conversion unit, optionally also the second shift conversion unit. This grid is kept separate from the system transporting the evaporated process condensate i.e. the process steam, as the process condensate contains impurities, such as methanol, which is undesired in some units of the plant to which steam from the grid steam system is led. The impurities, such as methanol, methyl formiate or amines e.g. MMA, DMA, TMA, are removed upon contact with the water gas shift catalyst. The pure steam and the process steam are not combined apart from when being added together to the first and optionally second shift conversion units, and/or to the catalytic reforming step.

In an embodiment according to the first aspect of the invention, at least a portion of the process steam stream and at least a portion of the pure steam stream are added to said second shift conversion unit. The associated benefit of this is increased flexibility in the process and plant, as steam is added at various points in the WGS conversion stage.

In an embodiment according to the first aspect of the invention, the process steam stream and the pure steam stream are added together, e.g. by combining the streams prior to adding to said first shift conversion unit, optionally to said second shift conversion unit. The associated benefit of this is the freedom to optimize the piping design

Hence, the invention includes:
the addition of at least a portion of evaporated process condensate i.e. process steam, mixed with pure steam thereby adjusting the steam/dry gas ratio inlet the first shift conversion unit i.e. the raw synthesis gas entering the first shift conversion unit;
the evaporation of the process condensate in the PC-boiler is performed by cooling synthesis gas outlet the first shift conversion unit and by condensing pure steam

The pure steam is used to control the optimal steam/dry molar gas ratio in the synthesis gas inlet the first shift conversion unit.

The optimal steam/dry molar gas ratio is between 0.3 to 0.8. The actual ratio depends on required conversion of CO and required overall energy consumption.

It is well known in the industry to produce steam from the cooling of the exit gas from a first shift conversion unit. This steam is normally mixed into a common steam system where it constitutes less than 35% of the total steam production. The common steam system supplies the required steam for the process/plant. Steam can be imported from an external source or exported to an external source, which requires that the steam quality follows agreed standards.

Some of the steam added to the process/plant will eventually be condensed and form the process condensate stream. To reduce raw water intake and minimize waste water, the process condensate is reused as liquid water supply for the steam generation. However, steam generated from the process condensate cannot be exported as it will not have a quality as per agreed standards, yet it can be added to the process. It is therefore important to separate steam generated from process condensate from pure steam generated from boiler feed water. This separation is secured by not mixing the steam generated from process condensate, i.e. the process steam, into the common steam system comprising the pure steam.

Steam is consumed in the process, either in the catalytic steam reforming of hydrocarbons or as part of the shift reaction CO+H₂O→CO₂+H₂. This means that steam from the evaporating process condensate, i.e. the process steam, cannot supply all the required steam to a given process mix point. Part of the steam added to the catalytic steam reforming step will be used for the reforming reaction CH₄+H₂O→CO+3H₂, and therefore results in a molar process condensate flow which is less than the molar steam flow to process mix point, e.g. prior to the catalytic steam reforming. In cases where the steam addition to the catalytic steam reforming step is very low, for instance when the steam reforming unit for producing the raw synthesis gas is an autothermal reformer alone or in combination with an SMR, it becomes necessary to add more steam to the raw synthesis gas i.e. prior to the first shift conversion unit. The required optimal molar steam flow for this additional mix point will in these cases be larger than the resulting molar process condensate flow.

As described farther above, a well-known method of reusing the process condensate for steam production is to send it to a process condensate stripper where it is stripped with pure steam. The resulting stripper steam is added to the mix points inlet the catalytic steam reforming and/or inlet the first shift conversion unit together with additional required pure steam. The stripped condensate is after further treatment used as makeup water for boiler feed water.

The present invention discloses therefore a simpler method where the process condensate is sent to an evaporator, i.e. the PC-boiler, and where substantially all of the process condensate is evaporated, i.e. except for a required blow down flow of minimum 1%. The evaporated process condensate, i.e. the process steam, can be added to the process similarly as the stripper steam in the above known procedure.

The PC-boiler is e.g. arranged in between the first and second shift conversion units, as described in the present application. A separate boiler such as a waste heat boiler is also suitably provided anywhere in the process/plant where pure steam production takes place, for example by cooling with this boiler the synthesis gas outlet of the catalytic steam reforming i.e. by cooling the raw synthesis gas immediately after exiting the steam reforming unit and prior to further cooling the raw synthesis gas in a BFW pre-heating unit; or for instance also by cooling the flue gas from the steam reforming unit. Pure steam can also be used to evaporate the process condensate, as also recited in the present application.

In accordance with the present invention, the process condensate can be evaporated in the PC-boiler by a combination of cooling the synthesis gas from the first shift and by condensing pure steam. Suitably, the resulting evaporated condensate, i.e. the process steam, is added to a mix point prior to the first shift and the optimal steam addition, ensuring a steam dry molar gas ratio in the resulting synthesis gas between 0.3 and 0.8. This ratio is thus controlled by adding additional pure steam generated separately by for instance the cooling of the raw synthesis gas (the synthesis gas from the catalytic steam reforming) and/or by cooling the flue gas from the steam reforming unit.

The PC-boiler can be placed anywhere in the process where pure steam production takes place. Suitably, the process condensate evaporation in the PC-boiler takes place by cooling the synthesis gas from the first shift, optionally by cooling the raw synthesis gas from the catalytic steam reforming, or from cooling the flue gas from the catalytic steam reforming, as this results in the lowest pure steam generation and thus the lowest amount of equipment for same.

Accordingly, in an embodiment according to the first aspect of the invention, step ii) also comprises the cooling of at least a portion of said pure steam stream.

The heat available after the shift may not always be enough to evaporate all the process condensate. Cooling pure steam is used as heat source to evaporate the rest, as illustrated in the appended figure by means of heat exchanging unit 280′, e.g. a heating coil, in the PC-boiler 280.

It would be understood that the cooling of synthesis gas comprises the cooling of a portion of the synthesis gas. It would also be understood that the cooling of said flue gas comprises the cooling of a portion of said flue gas.

Hence, the invention provides two separate process lines or systems, one for the generation of pure steam suitable for use as export steam or for provision of steam in the process, in particular for the water gas shift conversion, and a separate one for the generation of process steam in which for instance pure steam is used as heat exchanging medium for generating the process steam. The pure steam and the process steam are not combined, as the process condensate contains impurities, apart from when being added together to the first shift conversion unit, optionally to the second shift conversion unit, and/or to the catalytic steam reforming step as described farther above,

As also described above, the process steam may be generated by the use of pure steam and synthesis gas, or for instance also by the use of synthesis gas, pure steam and flue gas, or for instance also by the use of synthesis gas and flue gas, as heat exchange medium/media for the evaporation of the process condensate and thereby production of the process steam.

The invention enables the generation of the process steam in a single step i.e. step ii).

Step ii) is conducted in a process condensate boiler (PC-boiler), preferably having arranged therein one or more heat exchanger units for the cooling of synthesis gas, pure steam and/or flue gas. Accordingly, a single PC-boiler is utilized which combines therein the cooling of synthesis gas, together with the cooling pure steam and/or the flue gas. This a simpler and much more efficient approach than for instance using separate units for providing heat or evaporating process condensate using synthesis gas, and further downstream using additional unit(s) for finally evaporating the process condensate and thereby generating the process steam. This is also much simpler and efficient approach than providing separate steam drums for each steam line: one for collecting the pure steam and another one for collecting the process steam, as for instance disclosed in the above EP 3138810 A1 and U.S. Pat. No. 95,566,026 B1.

The use of the pure steam or flue gas, and synthesis gas, is preferably by indirect heat exchange i.e. no direct contact such as mixing, with the process condensate.

In particular, by combining the use of pure steam and synthesis gas in the generation of process steam, i.e. in a single PC-boiler, a more efficient use of the PC boiler is achieved, as both the pure steam and the synthesis gas may be used as heat exchange media with the PC-boiler. A smaller PC-boiler size is thereby also achieved.

In an embodiment, the steam reforming unit is a conventional steam methane reformer (SMR), e.g. a tubular reformer. In another embodiment, the stream reforming unit is an electrically heated reformer (e-SMR). In another embodiment, the steam reforming unit is an autothermal reforming (ATR) unit.

In particular, in an embodiment according to the first aspect of the invention, the steam reforming unit is an autothermal reforming (ATR) unit; or a combination of a conventional steam methane reformer (SMR), e.g. a tubular reformer, and an ATR unit; or an electrically heated reformer (e-SMR); or a combination of an e-SMR and an ATR unit, from which said raw synthesis gas is produced.

Use of steam reforming unit being a combination of a conventional steam methane reformer (SMR), e.g. a tubular reformer, and an ATR unit, is particularly suitable for production of hydrogen in large scale. The use of an e-SMR enables a more sustainable option, as the e-SMR is suitably powered by electricity generated from renewable sources such as any of wind, solar and hydropower. Other benefits result, such as reduced plot size due to the e-SMR being a more compact reactor.

It may also be advantageous to operate the process in which the steam reforming unit is an ATR unit, since contrary to the SMR, the ATR does not generate flue gas. In addition, the ATR enables operation with much lower steam to carbon molar ratios, thereby carrying less water in the process and thus reducing among other things downstream equipment size.

For more information on these reformers, details are herein provided by direct reference to Applicant's patents and/or literature. For instance, for tubular and autothermal reforming an overview is presented in “Tubular reforming and autothermal reforming of natural gas—an overview of available processes”, lb Dybkjaer, Fuel Processing Technology 42 (1995) 85-107. For a description of e-SMR which is a more recent technology, reference is given to in particular applicant's WO 2019/228797 A1.

For catalytic steam reforming where the steam reforming unit is ATR, the water gas shift conversion is preferably a HT-shift unit followed by MT or LT-shift unit. For catalytic steam reforming where the steam reforming unit is a conventional SMR, the shift conversion is preferably a MT-shift.

Water gas shift enables the enrichment of the synthesis gas in hydrogen, as is well-known in the art. The temperature of the synthesis gas exiting the first shift conversion unit, e.g. MT-shift unit is in the range 330-350° C., while the synthesis gas exiting the subsequent second shift conversion unit is in the range 200-250° C., hence the former is more suitable for use as heat exchanging medium for evaporating the process condensate. In particular for ATR, the exit temperature from HT shift is 430-460° C. and the exit temperature from downstream MT shift is 320-340° C. Here the PC boiler can be placed downstream both HT and MT shift converter.

In an embodiment according to the first aspect of the invention, the process condensate is preheated, preferably by indirect heat exchange, with:
pure steam used in said step ii), or a condensate thereof;
and/or
a portion of synthesis gas withdrawn after said WGS conversion stage, preferably after the second or third shift conversion unit, and preferably also before further cooling of the synthesis gas in one or more heat exchangers, i.e. BFW-preheating units, used for the generation of the pure steam stream.

Thus, a synthesis gas stream from preferably the second (and last) shift conversion unit (LT-shift) is divided into a synthesis gas stream from which water is removed for generating said process condensate stream, and a by-pass stream which is dedicated to preheating the process condensate, preferably by indirect heat exchange e.g. in a process condensate preheater. The thus preheated process condensate is then passed through said PC-boiler for generating the process steam. This embodiment is particularly suitable when conducting step ii) in which process steam is generated by the cooling of synthesis gas and pure steam.

These embodiments offer the advantage of in a simple and efficient manner to reduce the heat duty of the PC-boiler, thereby reducing its size.

In an embodiment according to the first aspect of the invention, a portion of the pure steam stream is used, i.e. withdrawn, as export steam. Hence, a portion of the pure steam is used for the generation of process steam, while another portion is used for export as this is not contaminated.

In an embodiment according to the first aspect of the invention, the process steam stream, e.g. a portion thereof, is mixed with the hydrocarbon feedstock prior to entering the steam reforming unit. The process steam is optionally combined with pure steam upon mixing with the hydrocarbon feedstock.

In an embodiment according to the first aspect of the invention, the synthesis gas is converted into a hydrogen product stream, the process condensate being generated in a process condensate separator, in which the process condensate separator also generates a water-depleted synthesis gas stream of which at least a portion is passed through a hydrogen purification stage, preferably in a Pressure Swing Adsorption unit (PSA unit), under the formation of said hydrogen product stream and an off-gas stream.

Thereby, a highly cost-effective process and plant for producing hydrogen is provided which advantageously integrates process steam and pure steam, without requiring the provision of a process condensate stripper for generating the process steam for use in the process.

In an embodiment according to the first aspect of the invention, the pure steam stream after being used for generating the process steam stream in the PC-boiler, is condensed and admixed to the boiler feed water (BFW) introduced in the process.

Thereby, a high thermal efficiency of the process/plant is obtained, as the BFW stream is replenished with condensed water from the pure steam stream.

In another general embodiment of the first aspect (process) of the invention, there is provided a process for producing a synthesis gas by catalytic steam reforming of a hydrocarbon feedstock in a steam reforming unit, wherein water is removed from the synthesis gas as a process condensate, wherein boiler feed water is introduced in the process, and wherein said process produces at least two separate steam streams: i) a pure steam stream which is generated from at least a portion of said boiler feed water (BFW) by the cooling of synthesis gas, and ii) a process steam stream which is generated by evaporating at least a portion of the process condensate by the cooling of synthesis gas;
wherein step ii) is conducted in a process condensate boiler (PC-boiler);
wherein said steam reforming unit produces a raw synthesis gas, and said synthesis gas is a process gas produced by passing said raw synthesis gas through a catalytic water-gas shift (WGS) conversion stage comprising the use of one or more water-gas shift conversion units;
wherein said one or more water-gas shift conversion units comprises a first shift conversion unit such as a high or medium-temperature shift conversion unit (HT or MT-shift unit) and subsequently a second shift conversion unit such as a medium or low temperature shift conversion unit (MT or LT-shift unit), and wherein said cooling of the synthesis gas in said step ii) is the cooling of a synthesis gas stream exiting said first or second shift conversion unit, e.g. said HT or MT-shift unit;
wherein at least a portion of the process steam stream and at least a portion of said pure steam stream are added to said first shift conversion unit.

In an embodiment of this another general embodiment, said reforming unit optionally generating a flue gas, and in step i) said pure steam stream which is generated from at least a portion of said boiler feed water (BFW), comprises:
i-1) pure steam generated at least partly by the cooling of the synthesis gas in one or more heat exchangers or boilers, and/or
i-2) pure steam generated by the cooling of said flue gas in one or more heat exchangers and boilers.

In an embodiment of this another general embodiment, said one or more water-gas shift conversion units comprises: a third shift conversion unit such as a low temperature shift conversion unit (LT-shift unit).

It would be understood, that any of the embodiments and associated benefits recited earlier in connection with the first aspect of the invention, may also apply in connection with this another general embodiment.

In a second aspect, the invention encompasses also a plant, i.e. process plant, for producing a synthesis gas. Accordingly, there is provided a plant for producing a synthesis gas comprising:
a steam reforming unit for converting a hydrocarbon feedstock into said synthesis gas;
optionally the steam reforming unit generating a flue gas, and the steam reforming unit comprising an outlet for withdrawing the flue gas;
a process condensate separator for removing water from said synthesis gas thereby forming a water-depleted syngas stream and a process condensate stream;
a steam system comprising one or more BFW heat exchangers and boilers for generating a pure steam stream, by indirect cooling of said synthesis gas in said one or more heat exchangers and boilers, such as in a BFW-preheating unit and in a waste heat boiler (WHB), for instance in a BFW-preheating unit and in a waste heat boiler (WHB) arranged in between said steam reforming unit and a downstream catalytic water-gas shift (WGS) conversion stage;
a process condensate (PC) system comprising a process condensate boiler (PC boiler) for generating a process steam stream, said PC boiler comprising:
   a heat exchange unit for evaporating at least a portion of said process condensate stream by the cooling of synthesis gas; and optionally:
   a heat exchange unit for evaporating at least a portion of said process condensate stream by cooling at least a portion of said pure steam stream as heat exchange medium, and/or a heat exchange unit for evaporating at least a portion of said process condensate stream by the cooling of said flue gas;
a catalytic water gas shift (WGS) conversion stage comprising one or more water-gas shift conversion units for enriching said synthesis gas in hydrogen, wherein said one or more water-gas shift conversion units comprises a first shift conversion unit such as a high or medium-temperature shift conversion unit (HT or MT-shift unit) and downstream a second shift conversion unit such as a medium or low temperature shift conversion unit (MT or LT-shift unit), and optionally a third shift conversion unit such as a low temperature shift conversion unit (LT-shift unit); wherein said cooling of synthesis gas in the PC-boiler is the cooling of a synthesis gas stream exiting said first or second shift conversion unit, e.g. said HT or MT-shift unit;
a conduit for leading at least a portion of said process steam stream and a conduit for leading at least a portion of said pure steam stream, to the first of said one or more water gas shift conversion units; optionally a conduit for leading at least a portion of said process steam stream and a conduit for leading at least a portion of said pure steam stream, to the second of said one more water gas shift conversion units;

and wherein said pure steam stream is pure steam generated in one or more boilers except for a boiler for cooling the synthesis gas from the first shift conversion unit, such as said PC-boiler.

It would be understood, that said first or second shift conversion unit is provided with an outlet for said synthesis gas stream exiting said unit, i.e. first or second shift conversion unit, and that a conduit is provided for directing the synthesis gas to said PC-boiler.

Suitably, the PC-boiler is in direct fluid communication with said outlet. Thus, there is no intermediate step or unit changing the composition of the synthesis gas upon entering the PC-boiler.

Accordingly, pure steam stream which is generated from at least a portion of said boiler feed water (BFW) by the cooling of synthesis gas, does not include pure steam after being used for generating the process steam stream, i.e. pure steam after being used in said PC-boiler. Process steam as well as pure steam generated in the process/plant elsewhere than in the PC boiler, are added to the first shift conversion unit A single or common PC-boiler may thus be utilized, as illustrated in the appended figure, which uses synthesis gas optionally together with pure steam and/or flue gas, for evaporating process condensate and thereby generate said process steam stream.

Furthermore, process steam as well as pure steam generated in the plant elsewhere than in the PC boiler, are added to the first shift conversion unit, optionally to the second shift conversion unit. Thereby it is possible to increase the amount of steam necessary for the WGS conversion compared to the prior art, while at the same time increasing plant flexibility, control and capacity.

In an embodiment according to the second aspect of the invention, the steam system comprises a grid i.e. a pipe network adapted for transporting pure steam generated in said one or more BFW heat exchangers and boilers such as waste heat boilers (WHB), for instance a WHB immediately downstream the steam reforming unit, and wherein the conduit for leading the at least a portion of said pure steam stream to the first and optionally to the second of said one or more water gas shift conversion units, is a conduit derived from said grid. The pipe network includes suitably also condensate pots and/or condensate drums to collect the pure stream. In a particular embodiment, the grid comprises means for transporting pure steam stream used during the generation of said process steam stream in said PC-boiler.

From the grid, a portion of the pure steam contained therein is conducted into the first and optionally second shift conversion units. This grid is kept separate from the system transporting the evaporated process condensate, i.e. the process steam, as the process condensate contains impurities, such as methanol, which is undesired in some units of the plant to which steam from the grid steam system is led. The impurities, such as methanol, are removed upon contact with the water gas shift catalyst of the first and second shift conversion unit. As described farther above in connection with the first aspect of the invention, the pure steam and the process steam are not combined apart from when being added together to the first shift conversion unit, optionally to the second shift conversion unit, and/or to the catalytic reforming step i.e. to the steam reforming unit.

In an embodiment according to the second aspect of the invention, the plant further comprises: a hydrogen purification unit, preferably a PSA-unit, for producing a hydrogen product from at least a portion of said water-depleted syngas stream, and an off-gas stream, e.g. a PSA off-gas stream.

The hydrogen product is then provided to end users, while the PSA off-gas may be used to assist in e.g. the steam reforming unit(s) such as fired heaters used therein for producing synthesis gas.

Preferably said indirect cooling of said synthesis gas with said BFW in one or more heat exchangers, i.e. BFW preheating units, is conducted upstream e.g. where the synthesis gas is the raw synthesis gas from steam reforming, and/or downstream said one or more shift water-gas shift conversion units e.g. where the synthesis gas is the process gas exiting the first and/or last shift conversion unit.

In an embodiment according to the second aspect of the invention, the steam reforming unit is an autothermal reforming unit (ATR unit); or a combination of a conventional steam methane reformer (SMR), e.g. a tubular reformer, and an ATR unit; or an electrically heated reformer (e-SMR), or a combination of an e-SMR and an ATR unit. The combination of SMR and ATR unit in particular is found to be suitable for production of hydrogen in large scale. The combination of e-SMR and ATR provides the additional advantage of a more compact steam reforming unit compared to SMR, thus significantly reducing plot size, and not least a significantly reduced carbon footprint, as the e-SMR is suitably powered by electricity from renewable sources, such as solar, wind and hydropower.

It would be understood, that the term “conventional SMR” and “SMR” are used interchangeably. Also, the term “tubular reformer” is, for the purposes of the present application, a particular instance of SMR.

In an embodiment according to the second aspect of the invention, the plant further comprises:
process condensate pressure means such as pump for leading said process condensate stream to said process condensate boiler;
a condensate pot and/or condensate drum for collecting a condensate product from said pure steam stream used during the generation of said process steam stream (by using a portion of said pure steam stream exiting the PC-boiler), and optionally pressurizing means such as a pump for transporting and mixing said condensate product (condensed pure steam) with BFW introduced in the plant, i.e. BFW import.

In an embodiment according to the second aspect of the invention, the plant further comprises:
a heat exchanger for indirect heating of the process condensate upstream said process condensate boiler, said indirect heating preferably being with a portion of the synthesis gas withdrawn downstream said one or more water-gas shift conversion units, the plant preferably also comprising means for dividing said portion of the synthesis gas.

The provision of such heat exchanger provides improved heat integration in the process and plant and enables a reduction of size of the PC-boiler.

Any of the embodiments of the first aspect of the invention may be used with the second aspect of the invention, and vice versa. It would be understood, that any of the associated benefits of the embodiments of the first aspect of the invention may be used with the second aspect of the invention, and vice versa.

Advantages of the invention include:
saving of a process condensate stripper, thereby simplifying the process/plant and thereby also resulting in lower capital expenditure (capex);
less treatment required for BFW preparation, thus also lower equipment and thereby lower capex;
optimal control of a main process parameter, namely steam dry gas molar ratio in the raw synthesis gas prior to entering the first shift conversion unit of the WGS conversion stage, by ensuring that adjustments take place via the use of abundant available pure steam

The accompanying figure shows a process layout in accordance with an embodiment of the invention, where pure steam and synthesis gas are used for the generation of process steam in a PC boiler, and where the process steam and the pure steam are conducted to the first shift conversion unit.

A process plant 200 is shown, in which a process condensate boiler, i.e. PC-boiler 280, arranged between first 220 and second 220′ shift conversion units includes: a heat exchange unit 280′ for evaporating process condensate stream by using pure steam as heat exchange medium, as well as a separate heat exchange unit 280″ for evaporating process condensate by the cooling of synthesis gas, i.e. by using synthesis gas as heat exchange medium.

A hydrocarbon feedstock (not shown) is catalytically reformed in a steam reforming unit such as an ATR unit (not shown) for producing a raw synthesis gas 212 which passes through a first boiler feed water (BFW) preheater (heat exchanging unit) 210, thereby generating a preheated (raw) synthesis gas stream 214 which is then passed through a catalytic shift conversion stage comprising the first unit in the form of a MT-shift unit 220, and second unit in the form of LT-shift unit 220′. Upstream heat exchanging unit 210, a waste heat boiler (WHB) (not shown) is suitably also arranged after the steam reforming unit for producing pure steam.

From the first unit 220, a synthesis gas 216 is withdrawn which is then used as the heat exchanging medium and thereby cooled in the heat exchange unit 280″ arranged within PC boiler 280. The cooled synthesis gas is further cooled in preheater 210′ before entering the LT-shift unit 220′ thereby producing a synthesis gas enriched in hydrogen 216′. Part of this stream 216′ is divided and used to preheat, via preheater or heat exchanging unit 260, the process condensate stream 228, which is pressurized by pump 250 to the PC boiler 280.

Another part of the synthesis gas stream 216′ is further cooled in BFW preheater 210″ using BFW import stream 234 being introduced into the process. The BFW after being used in BFW preheaters 210″ and 210′ and 210 is withdrawn to steam generation. The thus further cooled synthesis gas from BFW preheater 210″ is then combined with the cooled synthesis gas from preheater 260 and passed to PC separator 230. From the PC separator 230 a water depleted synthesis gas stream 220 is withdrawn which is finally passed to hydrogen purification unit 240, such as PSA-unit, under the formation of a hydrogen product stream 224 and PSA off-gas stream 226. The removed water in the PC separator 230 is withdrawn as said PC condensate stream 228, which results, after passing through the PC boiler 280, in process steam 232. This process steam 232 is added to the first shift unit 220 (MT shift unit) as depicted in the figure. Optionally, a portion of the process steam 232 is also added to the second shift unit 220′ (LT shift), not shown. Pure steam generated from BFW from heat exchange unit 210 and upstream WHB (not shown) is also added to the first shift conversion unit, as depicted by stream 234′, by mixing with the process steam 232, optionally also to the second shift conversion unit. Pure steam from the PC-boiler 280, passing through heat exchange unit 280′ is not added to the first or optionally to the second shift conversion unit. After being used for evaporating the process condensate in heat exchange unit 280′, the pure steam is collected in pot 290 and withdrawn therefrom, as depicted in the figure.

1. A process for producing a synthesis gas by catalytic steam reforming of a hydrocarbon feedstock in a steam reforming unit, said reforming unit optionally generating a flue gas, wherein water is removed from the synthesis gas as a process condensate, wherein boiler feed water is introduced in the process, and wherein said process produces at least two separate steam streams: i) a pure steam stream which is generated from at least a portion of said boiler feed water (BFW) by the cooling of synthesis gas, and ii) a process steam stream which is generated by evaporating at least a portion of the process condensate by the cooling of synthesis gas;
wherein step ii) is conducted in a process condensate boiler (PC-boiler);
wherein said steam reforming unit produces a raw synthesis gas, and said synthesis gas is a process gas produced by passing said raw synthesis gas through a catalytic water-gas shift (WGS) conversion stage comprising the use of one or more water-gas shift conversion units;
wherein said one or more water-gas shift conversion units comprises a first shift conversion unit and subsequently a second shift conversion unit, and optionally a third shift conversion unit, and wherein said cooling of the synthesis gas in said step ii) is the cooling of a synthesis gas stream exiting said first or second shift conversion unit;
wherein at least a portion of the process steam stream and at least a portion of said pure steam stream are added to said first shift conversion unit; and
wherein in step i) said pure steam stream which is generated from at least a portion of said boiler feed water (BFW), comprises:
i-1) pure steam generated at least partly by the cooling of the synthesis gas in one or more heat exchangers or boilers, and/or
i-2) pure steam generated by the cooling of said flue gas in one or more heat exchangers and boilers.

2. The process according to claim 1, wherein in step i-1) and/or i-2) said pure steam stream consists of: pure steam generated in one or more boilers, except for a boiler for cooling the synthesis gas from the first shift conversion unit.

3. The process according to claim 1, wherein at least a portion of the process steam stream and at least a portion of the pure steam stream are added to said second shift conversion unit.

4. The process according to claim 1, wherein the process steam stream and the pure steam stream are added together.

5. The process according to claim 1, wherein step ii) also comprises the cooling of at least a portion of said pure steam stream.

6. The process according to claim 1, wherein the steam reforming unit is an autothermal reforming (ATR) unit; or a combination of a conventional steam methane reformer (SMR), and an ATR unit; or an electrically heated reformer (e-SMR), or a combination of an e-SMR and an ATR unit, from which said raw synthesis gas is produced.

7. The process according to claim 1, wherein the process condensate is preheated with:
pure steam used in said step ii), or a condensate thereof;
and/or
a portion of synthesis gas withdrawn after said WGS conversion stage.

8. The process according to claim 1, wherein a portion of the pure steam stream is withdrawn as export steam.

9. The process according to claim 1, wherein the process steam stream is mixed with the hydrocarbon feedstock prior to entering the steam reforming unit; and optionally wherein the process steam is combined with pure steam upon mixing with the hydrocarbon feedstock.

10. The process according to claim 1, wherein the synthesis gas is converted into a hydrogen product stream, the process condensate being generated in a process condensate separator, in which the process condensate separator also generates a water-depleted synthesis gas stream of which at least a portion is passed through a hydrogen purification stage, under the formation of said hydrogen product stream and an off-gas stream.

11. The process according to claim 1, wherein the pure steam stream after being used for generating the process steam stream in the PC-boiler, is condensed and admixed to the boiler feed water (BFW) introduced in the process.

12. A plant for producing a synthesis gas comprising:
a steam reforming unit for converting a hydrocarbon feedstock into said synthesis gas and optionally generating a flue gas;
a process condensate separator for removing water from said synthesis gas thereby forming a water-depleted synthesis gas stream and a process condensate stream;
a steam system comprising one or more boiler feed water (BFW) heat exchangers and boilers for generating a pure steam stream by indirect cooling of said synthesis gas in said one or more heat exchangers and boilers;
a process condensate (PC) system comprising a process condensate boiler (PC boiler) for generating a process steam stream, said PC boiler comprising:
a heat exchange unit for evaporating at least a portion of said process condensate stream by the cooling of synthesis gas; and optionally:
a heat exchange unit for evaporating at least a portion of said process condensate stream by the cooling of at least a portion of said pure steam stream as heat exchange medium, and/or a heat exchange unit for evaporating at least a portion of said process condensate stream by the cooling of said flue gas;
a catalytic water gas shift (WGS) conversion stage comprising one or more water-gas shift conversion units for enriching said synthesis gas in hydrogen, wherein said one or more water-gas shift conversion units comprises a first shift conversion unit and downstream a second shift conversion unit; wherein said cooling of synthesis gas in the PC-boiler is the cooling of a synthesis gas stream exiting said first or second shift conversion unit;
a conduit for leading at least a portion of said process steam stream and a conduit for leading at least a portion of said pure steam stream, to the first of said one or more water gas shift conversion units; and
wherein said pure steam stream is pure steam generated in one or more boilers except for a boiler for cooling the synthesis gas from the first shift conversion unit.

13. The plant according to claim 12, wherein said steam reforming unit comprises an outlet for withdrawing flue gas generated in the steam reforming unit, and said PC boiler further comprises:
a heat exchange unit for evaporating at least a portion of said process condensate stream by the cooling of at least a portion of said pure steam stream as heat exchange medium, and/or a heat exchange unit for evaporating at least a portion of said process condensate stream by the cooling of said flue gas.

14. The plant according to claim 12, further comprising: a conduit for leading at least a portion of said process steam stream and a conduit for leading at least a portion of said pure steam stream, to the second of said one more water gas shift conversion units.

15. The plant according to claim 12, wherein the steam system comprises a grid i.e. a pipe network adapted for transporting pure steam generated in said one or more BFW heat exchangers and boilers, and wherein the conduit for leading the at least a portion of said pure steam stream to the first and optionally second of said one or more water gas shift conversion units, is a conduit derived from said grid.

16. The plant according to claim 12, further comprising: a hydrogen purification unit for producing a hydrogen product from at least a portion of said water-depleted synthesis gas stream, and an off-gas stream.

17. The plant according to claim 12, wherein the steam reforming unit is an autothermal reforming (ATR) unit; or a combination of a conventional steam methane reformer (SMR), and an ATR unit; or an electrically heated reformer (e-SMR), or a combination of an e-SMR and an ATR unit.

18. The plant according to claim 12, further comprising:
process condensate pressure means for leading said process condensate stream to said process condensate boiler;
a condensate pot and/or condensate drum for collecting a condensate product from said pure steam stream used during the generation of said process steam stream, and optionally pressurizing means for transporting and mixing said condensate product with BFW introduced in the plant.

19. The plant according to claim 12, further comprising a heat exchanger for indirect heating of the process condensate upstream said process condensate boiler.
